(19) United States
(12) Patent Application Publication
(10) Pub. No.: US 2021/0289154 A1
(43) Pub. Date: Sep. 16, 2021

(54) HIGH DYNAMIC RANGE IMAGING PIXELS WITH CHARGE OVERFLOW

(71) Applicant: SEMICONDUCTOR COMPONENTS INDUSTRIES, LLC, Phoenix, AZ (US)

(72) Inventors: Richard Scott JOHNSON, Boise, ID (US); Sergey VELICHKO, Boise, ID (US)

(73) Assignee: SEMICONDUCTOR COMPONENTS INDUSTRIES, LLC, Phoenix, AZ (US)

(21) Appl. No.: 16/814,771

(22) Filed: Mar. 10, 2020

(51) Int. Cl. H04N 5/355; H04N 5/378; H04N 5/353

(52) U.S. Cl. CPC H04N 5/35572; H04N 5/353; H04N 5/378

(57) ABSTRACT

A high dynamic range imaging pixel may include a photodiode, an overflow node, and an overflow path between the photodiode and the overflow node. The imaging pixel may have an overlapping overflow integration time and photodiode integration time. The overflow integration time may be shorter than the photodiode integration time. At the end of the overflow integration time, an uncorrelated double sample of overflow charge may be obtained. The capacity of the photodiode is then increased and charge continues to accumulate in the photodiode until the conclusion of the photodiode integration time. A correlated double sample of charge from the photodiode may then be obtained. For additional increases to dynamic range, the overflow charge may be repeatedly sampled and reset throughout the overflow integration time, effectively increasing the overflow capacity. The overflow samples may be integrated on a buffer to track the total overflow charge.

### BACKGROUND

This relates generally to imaging devices, and more particularly, to imaging devices having high dynamic range imaging pixels.

Image sensors are commonly used in electronic devices such as cellular telephones, cameras, and computers to capture images. In a typical arrangement, an image sensor includes an array of image pixels arranged in pixel rows and pixel columns. Circuitry may be coupled to each pixel column for reading out image signals from the image pixels. Typical image pixels contain a photodiode for generating charge in response to incident light. Image pixels may also include a charge storage region for storing charge that is generated in the photodiode. Image sensors can operate using a global shutter, rolling shutter, per-pixel controlled, or per-pixel-group controlled scheme.

Some conventional image sensors may be able to operate in a high dynamic range (HDR) mode. HDR operation may be accomplished in image sensors by assigning alternate rows of pixels different integration times. However, conventional HDR image sensors may sometimes experience lower than desired resolution, lower than desired sensitivity, higher than desired noise levels, and lower than desired quantum efficiency.

It would therefore be desirable to be able to provide improved high dynamic range operation in image sensors.

### BRIEF DESCRIPTION OF THE DRAWINGS

FIG. 1 is a diagram of an illustrative electronic device having an image sensor in accordance with an embodiment.

FIG. 2 is a diagram of an illustrative pixel array and associated readout circuitry for reading out image signals in an image sensor in accordance with an embodiment.

FIG. 3A is a schematic diagram of an illustrative imaging pixel with a photodiode, an overflow node, and an overflow path from the photodiode to the overflow node in accordance with an embodiment.

FIG. 3B is a timing diagram showing an illustrative method of operating the imaging pixel of FIG. 3A in accordance with an embodiment.

FIG. 4 is a circuit diagram of an illustrative imaging pixel with an overflow node formed from a storage capacitor that is coupled between a gain select transistor and reset transistor in accordance with an embodiment.

FIG. 5 is a circuit diagram of an illustrative imaging pixel with an overflow node formed from a storage capacitor that is coupled between a gain select transistor and a bias voltage supply terminal in accordance with an embodiment.

FIG. 6 is a circuit diagram of an illustrative imaging pixel with an overflow node formed from a storage capacitor that is coupled directly to the photodiode by an overflow transistor in accordance with an embodiment.

FIG. 7 is a circuit diagram of an illustrative imaging pixel with two photodiodes, an overflow node, and an overflow path from the photodiode to the overflow node in accordance with an embodiment.

FIG. 8 is a timing diagram showing an illustrative method of operating an imaging pixel with an overflow path in accordance with an embodiment.

FIG. 9A is a schematic diagram of an illustrative imaging pixel with a photodiode, an overflow node, a buffer, and an overflow path from the photodiode to the overflow node in accordance with an embodiment.

FIG. 9B is a timing diagram showing an illustrative method of operating the imaging pixel of FIG. 9A in accordance with an embodiment.

FIG. 10 is a circuit diagram of an illustrative imaging pixel having a buffer formed between the floating diffusion region and the source follower transistor in accordance with an embodiment.

FIG. 11 is a circuit diagram of an illustrative imaging pixel having a buffer formed between first and second source follower transistors in accordance with an embodiment.

FIG. 12 is a timing diagram showing an illustrative method of operating an imaging pixel with an overflow path and a buffer in accordance with an embodiment.

FIG. 13 is a timing diagram showing how the overflow control signal may be dynamically changed during an overflow integration time in accordance with an embodiment.

### DETAILED DESCRIPTION

Embodiments of the present invention relate to image sensors. It will be recognized by one skilled in the art that the present exemplary embodiments may be practiced without some or all of these specific details. In other instances, well-known operations have not been described in detail in order not to unnecessarily obscure the present embodiments.

Electronic devices such as digital cameras, computers, cellular telephones, and other electronic devices may include image sensors that gather incoming light to capture an image. The image sensors may include arrays of pixels. The pixels in the image sensors may include photosensitive elements such as photodiodes that convert the incoming light into image signals. Image sensors may have any number of pixels (e.g., hundreds or thousands or more). A typical image sensor may, for example, have hundreds of thousands or millions of pixels (e.g., megapixels). Image sensors may include control circuitry such as circuitry for operating the pixels and readout circuitry for reading out image signals corresponding to the electric charge generated by the photosensitive elements.

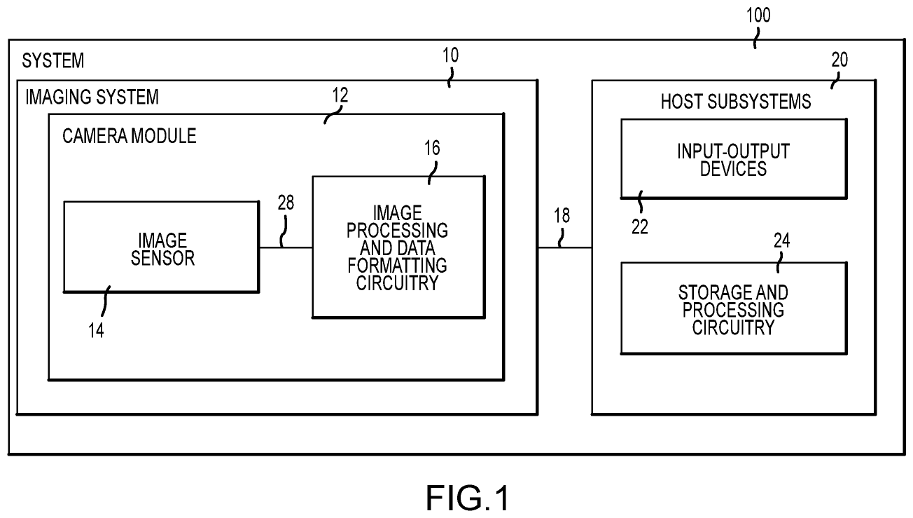

FIG. 1 is a diagram of an illustrative imaging and response system including an imaging system that uses an image sensor to capture images. System 100 of FIG. 1 may be an electronic device such as a camera, a cellular telephone, a video camera, or other electronic device that captures digital image data, may be a vehicle safety system (e.g., an active braking system or other vehicle safety system), may be a surveillance system, or may be any other desired type of system.

As shown in FIG. 1, system 100 may include an imaging system such as imaging system 10 and host subsystems such as host subsystem 20. Imaging system 10 may include camera module 12. Camera module 12 may include one or more image sensors 14 and one or more lenses.

Each image sensor in camera module 12 may be identical or there may be different types of image sensors in a given image sensor array integrated circuit. During image capture operations, each lens may focus light onto an associated image sensor 14. Image sensor 14 may include photosensitive elements (i.e., pixels) that convert the light into digital data. Image sensors may have any number of pixels (e.g., hundreds, thousands, millions, or more). A typical image sensor may, for example, have millions of pixels (e.g., megapixels). As examples, image sensor 14 may include bias circuitry (e.g., source follower load circuits), sample and hold circuitry, correlated double sampling (CDS) circuitry, amplifier circuitry, analog-to-digital converter circuitry, data output circuitry, memory (e.g., buffer circuitry), address circuitry, etc.

Still and video image data from camera sensor 14 may be provided to image processing and data formatting circuitry 16 via path 28. Path 28 may be a connection through a serializer/deserializer (SERDES) which is used for high speed communication and may be especially useful in automotive systems. Image processing and data formatting circuitry 16 may be used to perform image processing functions such as data formatting, adjusting white balance and exposure, implementing video image stabilization, face detection, etc. Image processing and data formatting circuitry 16 may also be used to compress raw camera image files if desired (e.g., to Joint Photographic Experts Group or JPEG format). In a typical arrangement, which is sometimes referred to as a system on chip (SOC) arrangement, camera sensor 14 and image processing and data formatting circuitry 16 are implemented on a common semiconductor substrate (e.g., a common silicon image sensor integrated circuit die). If desired, camera sensor 14 and image processing circuitry 16 may be formed on separate semiconductor substrates. For example, camera sensor 14 and image processing circuitry 16 may be formed on separate substrates that have been stacked.

Imaging system 10 (e.g., image processing and data formatting circuitry 16) may convey acquired image data to host subsystem 20 over path 18. Path 18 may also be a connection through SERDES. Host subsystem 20 may include processing software for detecting objects in images, detecting motion of objects between image frames, determining distances to objects in images, filtering or otherwise processing images provided by imaging system 10.

If desired, system 100 may provide a user with numerous high-level functions. In a computer or advanced cellular telephone, for example, a user may be provided with the ability to run user applications. To implement these functions, host subsystem 20 of system 100 may have input-output devices 22 such as keypads, input-output ports, joysticks, and displays and storage and processing circuitry 24. Storage and processing circuitry 24 may include volatile and nonvolatile memory (e.g., random-access memory, flash memory, hard drives, solid-state drives, etc.). Storage and processing circuitry 24 may also include microprocessors, microcontrollers, digital signal processors, application specific integrated circuits, etc.

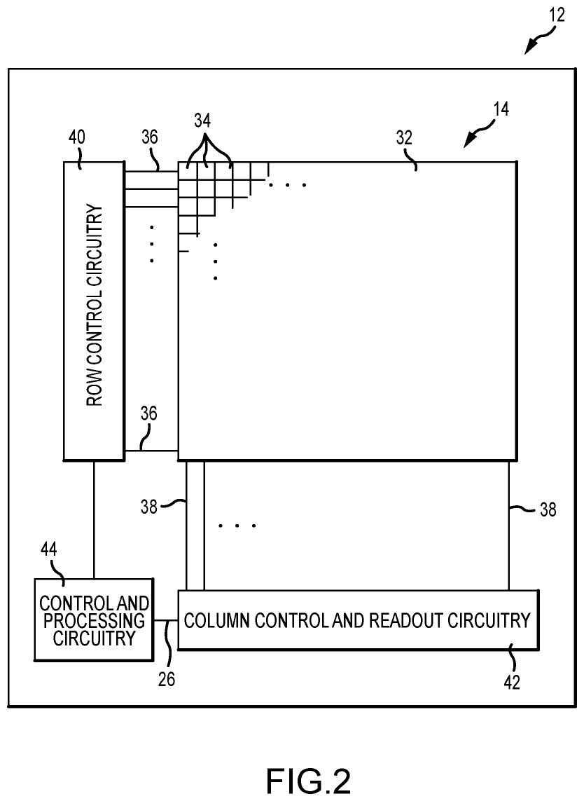

An example of an arrangement for camera module 12 of FIG. 1 is shown in FIG. 2. As shown in FIG. 2, camera module 12 includes image sensor 14 and control and processing circuitry 44. Control and processing circuitry 44 may correspond to image processing and data formatting circuitry 16 in FIG. 1. Image sensor 14 may include a pixel array such as array 32 of pixels 34 (sometimes referred to herein as image sensor pixels, imaging pixels, or image pixels 34) and may also include control circuitry 40 and 42. Control and processing circuitry 44 may be coupled to row control circuitry 40 and may be coupled to column control and readout circuitry 42 via data path 26. Row control circuitry 40 may receive row addresses from control and processing circuitry 44 and may supply corresponding row control signals to image pixels 34 over control paths 36 (e.g., dual conversion gain control signals, pixel reset control signals, charge transfer control signals, blooming control signals, row select control signals, or any other desired pixel control signals). Column control and readout circuitry 42 may be coupled to the columns of pixel array 32 via one or more conductive lines such as column lines 38. Column lines 38 may be coupled to each column of image pixels 34 in image pixel array 32 (e.g., each column of pixels may be coupled to a corresponding column line 38). Column lines 38 may be used for reading out image signals from image pixels 34 and for supplying bias signals (e.g., bias currents or bias voltages) to image pixels 34. During image pixel readout operations, a pixel row in image pixel array 32 may be selected using row control circuitry 40 and image data associated with image pixels 34 of that pixel row may be read out by column control and readout circuitry 42 on column lines 38.

Column control and readout circuitry 42 may include column circuitry such as column amplifiers for amplifying signals read out from array 32, sample and hold circuitry for sampling and storing signals read out from array 32, analog-to-digital converter circuits for converting read out analog signals to corresponding digital signals, and column memory for storing the read out signals and any other desired data. Column control and readout circuitry 42 may output digital pixel values to control and processing circuitry 44 over line 26.

Array 32 may have any number of rows and columns. In general, the size of array 32 and the number of rows and columns in array 32 will depend on the particular implementation of image sensor 14. While rows and columns are generally described herein as being horizontal and vertical, respectively, rows and columns may refer to any grid-like structure (e.g., features described herein as rows may be arranged vertically and features described herein as columns may be arranged horizontally).

Pixel array 32 may be provided with a color filter array having multiple color filter elements which allows a single image sensor to sample light of different colors. As an example, image sensor pixels such as the image pixels in array 32 may be provided with a color filter array which allows a single image sensor to sample red, green, and blue (RGB) light using corresponding red, green, and blue image sensor pixels arranged in a Bayer mosaic pattern. The Bayer mosaic pattern consists of a repeating unit cell of two-by-two image pixels, with two green image pixels diagonally opposite one another and adjacent to a red image pixel diagonally opposite to a blue image pixel. In another suitable example, the green pixels in a Bayer pattern are replaced by broadband image pixels having broadband color filter elements (e.g., clear color filter elements, yellow color filter elements, etc.). These examples are merely illustrative and, in general, color filter elements of any desired color and in any desired pattern may be formed over any desired number of image pixels 34.

If desired, array 32 may be part of a stacked-die arrangement in which pixels 34 of array 32 are split between two or more stacked substrates. In such an arrangement, each of the pixels 34 in the array 32 may be split between the two dies at any desired node within the pixel. As an example, a node such as the floating diffusion node may be formed across two dies. Pixel circuitry that includes the photodiode and the circuitry coupled between the photodiode and the desired node (such as the floating diffusion node, in the present example) may be formed on a first die, and the remaining pixel circuitry may be formed on a second die. The desired node may be formed on (i.e., as a part of) a coupling structure (such as a conductive pad, a micro-pad, a conductive interconnect structure, or a conductive via) that connects the two dies. Before the two dies are bonded, the coupling structure may have a first portion on the first die and may have a second portion on the second die. The first die and the second die may be bonded to each other such that first portion of the coupling structure and the second portion of the coupling structure are bonded together and are electrically coupled. If desired, the first and second portions of the coupling structure may be compression bonded to each other. However, this is merely illustrative. If desired, the first and second portions of the coupling structures formed on the respective first and second dies may be bonded together using any metal-to-metal bonding technique, such as soldering or welding.

As mentioned above, the desired node in the pixel circuit that is split across the two dies may be a floating diffusion node. Alternatively, the desired node in the pixel circuit that is split across the two dies may be the node between a floating diffusion region and the gate of a source follower transistor (i.e., the floating diffusion node may be formed on the first die on which the photodiode is formed, while the coupling structure may connect the floating diffusion node to the source follower transistor on the second die), the node between a floating diffusion region and a source-drain node of a transfer transistor (i.e., the floating diffusion node may be formed on the second die on which the photodiode is not located), the node between a source-drain node of a source follower transistor and a row select transistor, or any other desired node of the pixel circuit.

In general, array 32, row control circuitry 40, column control and readout circuitry 42, and control and processing circuitry 44 may be split between two or more stacked substrates. In one example, array 32 may be formed in a first substrate and row control circuitry 40, column control and readout circuitry 42, and control and processing circuitry 44 may be formed in a second substrate. In another example, array 32 may be split between first and second substrates (using one of the pixel splitting schemes described above) and row control circuitry 40, column control and readout circuitry 42, and control and processing circuitry 44 may be formed in a third substrate.

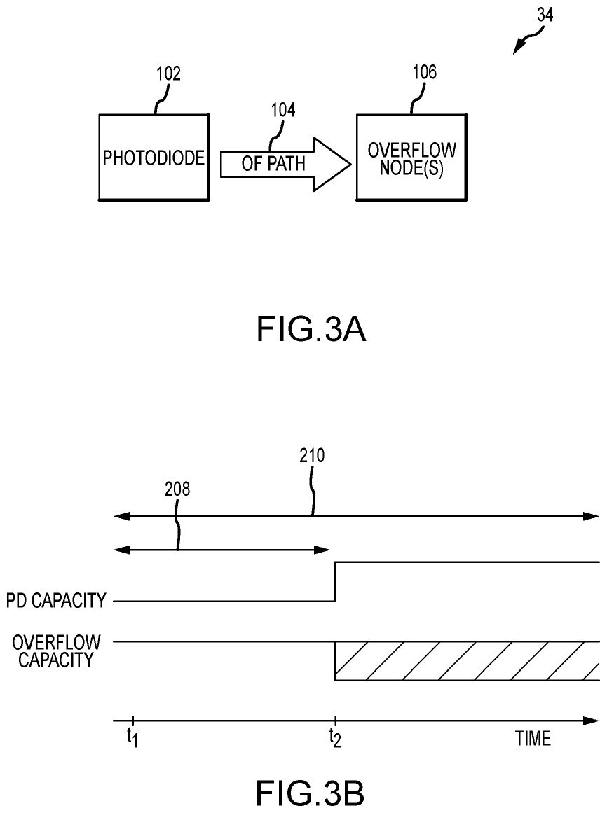

It may be desirable to increase the dynamic range of imaging pixels within image sensor 14. To increase the dynamic range of an imaging pixel, the imaging pixel may include an overflow path. A schematic diagram of an imaging pixel with an overflow path is shown in FIG. 3A. As shown, the imaging pixel may include a photodiode 102. The photodiode may generate charge in response to incident light. Once charge accumulated in the photodiode exceeds a given level, the charge may overflow from the photodiode to overflow node(s) 106 via overflow (OF) path 104. Charge may be read out from the overflow node 106 in addition to photodiode 102. In this way, excess charge that overflows from photodiode is still captured and read out by the imaging pixel (instead of being discarded). Capturing this excess charge effectively increases the capacity (and therefore dynamic range) of the imaging pixel.

The overflow path in the imaging pixel may be controlled by a transistor that sets a dynamic potential barrier for charge to overflow from the photodiode. When the transistor is deasserted (e.g., the signal provided to the transistor gate is low), the capacity of the photodiode may be large (e.g., a large amount of charge needs to accumulate before charge overflows from the photodiode to the overflow node). The signal provided to the transistor gate may be raised to an intermediate level to lower the capacity of the photodiode and allow charge to overflow from the photodiode to the overflow node at a lower level. Multiple overflow nodes may optionally be arranged in series such that overflow charge cascades through the multiple overflow nodes.

FIG. 3B is a timing diagram illustrating how the photodiode capacity may be modulated relative to the overflow time. At t₁, the photodiode capacity may be low to allow for an optimized charge-flow path from the photodiode to the overflow node. This arrangement may be maintained for an overflow integration period 208. At t₂, the photodiode capacity is increased. This may decrease the likelihood of charge overflowing to the overflow node (indicated by the shaded portion under the overflow capacity after t₂). The photodiode charge may be read out after the conclusion of photodiode readout period 210.

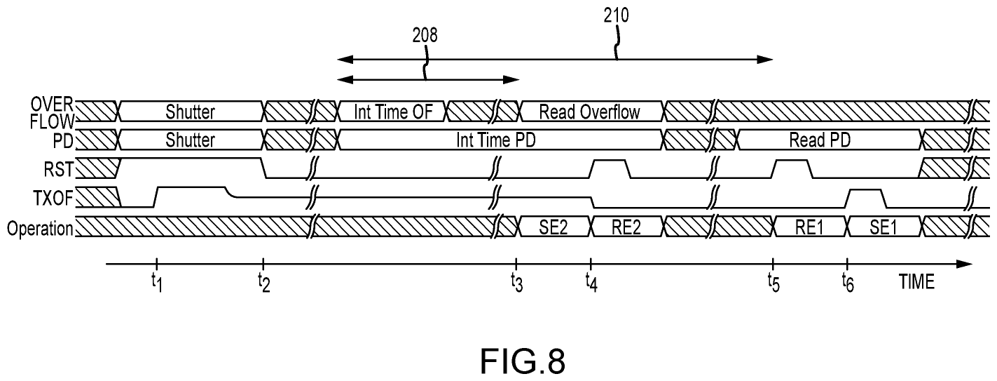

In high light conditions, charge will overflow from the photodiode to the overflow node during overflow integration time 208. The overflow charge is then sampled from the overflow node at the conclusion of overflow integration time 208 and/or just prior to photodiode sampling at the end of integration time 210. Meanwhile, if light conditions are low, no charge will overflow during overflow integration time 208. However, charge is allowed to accumulate throughout integration time 210 (both when the photodiode has a reduced capacity and when the photodiode has a full capacity). This long integration time enables the pixel to obtain useful signal even at very low light levels. In this way, the imaging pixel has an increased dynamic range. A more detailed timing diagram is shown and discussed in connection with FIG. 8.

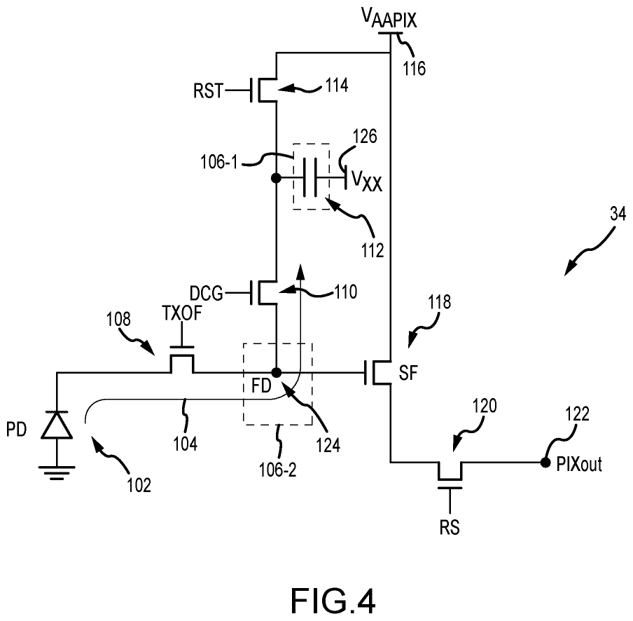

An overflow scheme of the type shown in FIGS. 3A and 3B may be used in many different type of pixels. In general, any pixel may be designed to include a photodiode 102, overflow path 104, and overflow node 106 of the type shown in FIGS. 3A and 3B. FIGS. 4-7 show some examples of pixels that include a photodiode 102, overflow path 104, and overflow node 106.

FIG. 4 is a circuit diagram of an illustrative imaging pixel having a photosensitive element and a storage capacitor. As shown in FIG. 4, image pixel 34 includes photosensitive element 102 (sometimes referred to as photodiode 102). Photosensitive element 102 has a first terminal that is coupled to ground. The second terminal of photosensitive element 102 is coupled to transistor 108.

Transistor 108 (sometimes referred to as threshold transistor 108) is coupled between photodiode 102 and floating diffusion region 124. Floating diffusion region 124 may be a doped semiconductor region (e.g., a region in a silicon substrate that is doped by ion implantation, impurity diffusion, or other doping process). Gain select transistor 110 has a first terminal coupled to floating diffusion region 124 and a second terminal coupled to storage capacitor 112. Storage capacitor 112 may be coupled between gain select transistor 110 and a bias voltage supply terminal 126 that provides bias voltage V_{XX}. In other words, capacitor 112 has a first plate coupled to gain select transistor 110 (and reset transistor 114) and a second plate coupled to bias voltage supply terminal 126.

Source follower transistor 118 has a gate terminal coupled to floating diffusion region 124. Source follower transistor 118 also has a first source-drain terminal coupled to voltage supply 116. Voltage supply 116 may provide a power supply voltage V_{AAPIX}. In this application, each transistor is illustrated as having three terminals: a source, a drain, and a gate. The source and drain terminals of each transistor may be changed depending on how the transistors are biased and the type of transistor used. For the sake of simplicity, the source and drain terminals are referred to herein as source-drain terminals or simply terminals. A second source-drain terminal of source follower transistor 118 is coupled to output terminal 122 (pixout) through row select transistor 120. The source follower transistor, row select transistor, and output terminal may sometimes collectively be referred to as a readout circuit or as readout circuitry. Reset transistor 114 may be coupled between capacitor 112 and voltage supply 116.

A gate terminal of transistor 108 (sometimes referred to as transfer transistor 108 or threshold transistor 108) receives control signal TXOF. A gate terminal of transistor 114 (sometimes referred to as reset transistor 114) receives control signal RST. A gate terminal of transistor 120 (sometimes referred to as row select transistor 120) receives control signal RS. A gate terminal of transistor 110 (sometimes referred to as gain transistor 110, conversion gain transistor 110, gain select transistor 110, conversion gain select transistor 110, etc.) receives control signal DCG. Control signals TXOF, RST, RS, and DCG may be provided by row control circuitry (e.g., row control circuitry 40 in FIG. 2) over control paths (e.g., control paths 36 in FIG. 2).

Similar to as discussed in connection with FIG. 3A, the imaging pixel of FIG. 4 includes a photodiode 102 and overflow nodes 106. Specifically, in the imaging pixel of FIG. 4, capacitor 112 may serve as a first overflow node 106-1 and floating diffusion region 124 may serve as a second overflow node 106-2. Charge follows overflow path 104 from photodiode 102 to overflow node 106-1 and/or 106-2. The specific examples of overflow nodes of FIG. 4 are merely illustrative. In general, any of the overflow nodes may be replaced with one or more components that can store charge (e.g., one or more storage capacitors, one or more storage diodes, one or more storage gates, one or more floating diffusion regions, etc.). The overflow nodes may also sometimes be referred to as storage regions.

Gain select transistor 110 and dual conversion gain capacitor 112 may be used by pixel 34 to implement a dual conversion gain mode. In particular, pixel 34 may be operable in a high conversion gain mode and in a low conversion gain mode. If gain select transistor 110 is disabled, pixel 34 will be placed in a high conversion gain mode. If gain select transistor 110 is enabled, pixel 34 will be placed in a low conversion gain mode. When gain select transistor 110 is turned on, the dual conversion gain capacitor 112 may be switched into use to provide floating diffusion region 124 with additional capacitance. This results in lower conversion gain for pixel 34. When gain select transistor 110 is turned off, the additional loading of the capacitor is removed and the pixel reverts to a relatively higher pixel conversion gain configuration.

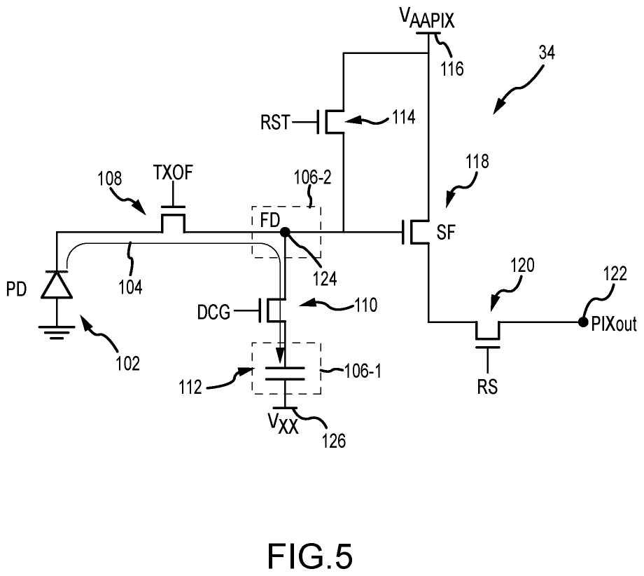

The imaging pixel of FIG. 4 is merely illustrative. Various modifications may be made to the imaging pixel. FIG. 5 is a circuit diagram of an imaging pixel that includes a storage capacitor that is coupled to a separate bias voltage. The imaging pixel of FIG. 5 is similar to the imaging pixel of FIG. 4. Specifically, the imaging pixel includes a photodiode 102, a floating diffusion region 124, a transistor 108 coupled between the photodiode and the floating diffusion region, a source follower transistor 118 coupled to the floating diffusion region, a row select transistor 120 coupled to the source follower transistor, a reset transistor 114, and a voltage supply terminal 116 that provides power supply voltage V_{AAPIX}. These duplicate components will not be described again to avoid repetition.

Imaging pixel 34 also includes a gain select transistor 110 coupled between floating diffusion region 124 and capacitor 112. However, in FIG. 4 the capacitor is coupled between gain select transistor 110 and reset transistor 114. In FIG. 5, the capacitor is coupled between gain select transistor 110 and a bias voltage supply terminal 126 that provides bias voltage V_{XX}. In other words, capacitor 112 has a first plate coupled to gain select transistor 110 and a second plate coupled to bias voltage supply terminal 126. This allows for the voltage applied to the second plate to be modulated during operation of the imaging pixel (e.g., the voltage may be kept low during an integration time). Controlling the voltage applied to the capacitor in this manner may allow for dark current to be reduced.

Similar to as discussed in connection with FIG. 3A, the imaging pixel of FIG. 5 includes a photodiode 102 and overflow nodes 106. Specifically, in the imaging pixel of FIG. 5, capacitor 112 may serve as a first overflow node 106-1 and floating diffusion region 124 may serve as a second overflow node 106-2. Charge follows overflow path 104 from photodiode 102 to overflow node 106-1 and/or 106-2. The specific examples of overflow nodes of FIG. 5 are merely illustrative. In general, any of the overflow nodes may be replaced with one or more components that can store charge (e.g., one or more storage capacitors, one or more storage diodes, one or more storage gates, one or more floating diffusion regions, etc.).

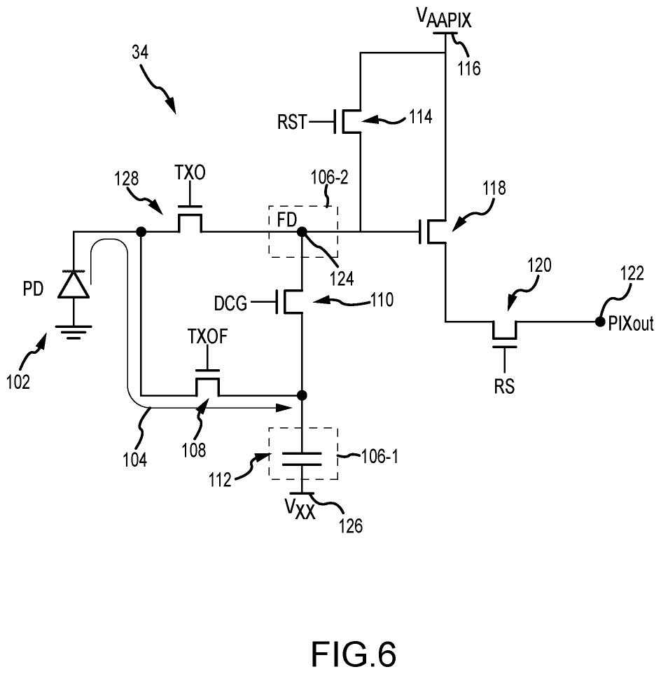

FIG. 6 is a circuit diagram of an imaging pixel that includes a storage capacitor that is coupled to a bias voltage. The imaging pixel of FIG. 6 is similar to the imaging pixel of FIG. 5. Specifically, the imaging pixel includes a photodiode 102, a floating diffusion region 124, a source follower transistor 118 coupled to the floating diffusion region, a row select transistor 120 coupled to the source follower transistor, a voltage supply terminal 116 that provides power supply voltage V_{AAPIX}, a reset transistor 114 coupled between the floating diffusion region 124 and power supply terminal 116, a storage capacitor 112, a gain select transistor 110 coupled between the floating diffusion region and the storage capacitor, and a bias voltage supply terminal 126 coupled to the second plate of the storage capacitor. These duplicate components will not be described again to avoid repetition.

Imaging pixel 34 also includes a transistor coupled between photodiode 102 and floating diffusion region 124. However, in FIG. 5 the overflow path 104 passes through this transistor whereas in FIG. 6 a transfer transistor 128 is included between PD 102 and FD 124 that is not a part of the overflow path. In FIG. 6, a supplemental overflow transistor 108 is provided between the photodiode 102 and a node that is interposed between gain select transistor 110 and storage capacitor 112. This may allow for charge to overflow directly into storage capacitor 112 (as opposed to passing through intervening floating diffusion region 124 as in FIG. 5).

Similar to as discussed in connection with FIG. 3A, the imaging pixel of FIG. 6 includes a photodiode 102 and overflow nodes 106. Specifically, in the imaging pixel of FIG. 5, capacitor 112 may serve as a first overflow node 106-1 and floating diffusion region 124 may serve as a second overflow node 106-2. Charge follows overflow path 104 from photodiode 102 to overflow node 106-1 and/or 106-2. The specific examples of overflow nodes of FIG. 6 are merely illustrative. In general, any of the overflow nodes may be replaced with one or more components that can store charge (e.g., one or more storage capacitors, one or more storage diodes, one or more storage gates, one or more floating diffusion regions, etc.).

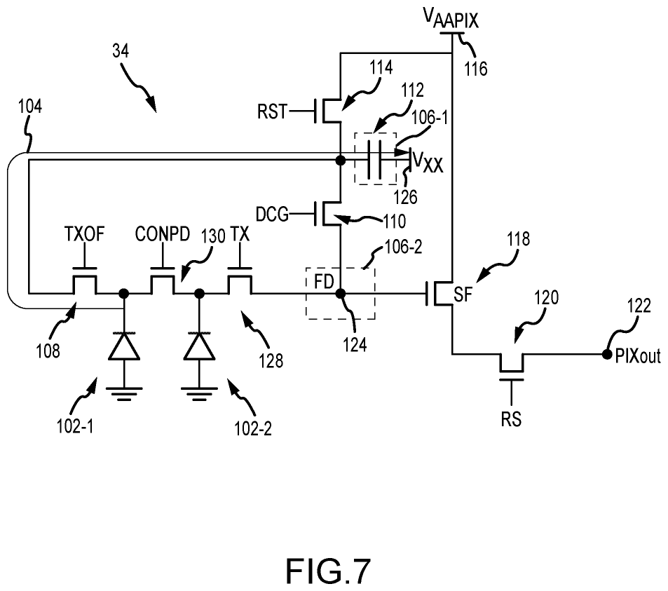

An imaging pixel with more than one photodiode may also use an overflow scheme of the type described herein. FIG. 7 is a circuit diagram of an illustrative imaging pixel with first and second photodiodes. The imaging pixel of FIG. 7 includes first and second photodiodes 102-1 and 102-2. Overflow transistor 108 may be interposed between photodiode 102-1 and storage capacitor 112. Storage capacitor 112 may be coupled between gain select transistor 110 and bias voltage supply terminal 126. Gain select transistor 110 is coupled between capacitor 112 and floating diffusion region 124. An additional transfer transistor 128 is coupled between photodiode 102-2 and floating diffusion region 124. A transistor 130 may also be coupled between photodiodes 102-1 and 102-2. Photodiode 102-1 may have a lower sensitivity to incident light than photodiode 102-2.

Similar to as discussed in connection with FIG. 3A, even though the imaging pixel of FIG. 7 includes multiple photodiodes, the imaging pixel still includes overflow nodes 106. Specifically, in the imaging pixel of FIG. 7, capacitor 112 may serve as a first overflow node 106-1 and floating diffusion region 124 may serve as a second overflow node 106-2. Charge follows overflow path 104 from photodiode 102-1 to overflow node 106-1 and/or 106-2. The specific examples of overflow nodes of FIG. 7 are merely illustrative. In general, any of the overflow nodes may be replaced with one or more components that can store charge (e.g., one or more storage capacitors, one or more storage diodes, one or more storage gates, one or more floating diffusion regions, etc.).

FIG. 8 is a timing diagram showing an illustrative method of operation of an imaging pixel with an overflow path (e.g., any of the imaging pixels of FIGS. 4-7). Although the pixels have variations as previously discussed, the principles shown in the timing diagram of FIG. 8 may applicable to all of the depicted pixels. Minor modifications may be made to the timing diagram to suit the particular design of the imaging pixel being used and the application of the imaging pixel. For simplicity, the timing diagram will be discussed relative to FIG. 5. Initially, at t₁, the reset transistor 114 may be asserted and the threshold transistor 108 may be asserted. This resets the charge at floating diffusion region 124 and photodiode 102. The gain select transistor 110 may also be asserted to reset storage capacitor 112 at this time. At t₂, after the reset period, the reset transistor is deasserted and the TXOF control signal for transistor 108 is set to an intermediate value. This sets a potential barrier for charge accumulating in the photodiode. Once the accumulating charge exceeds the potential barrier, the charge overflows to an overflow node (e.g., floating diffusion region 124 and/or storage capacitor 112). The overflow integration period 208 may end at t₃. At t₃, the charge from the overflow nodes may be sampled (e.g., by asserting row select transistor 120). The readout may begin with an E2 sample (SE2) that is obtained at t₃. The E2 readout may refer to readout of the overflow charge (that is stored at floating diffusion region 124 and/or storage capacitor 112). The E2 readout may include readout of a sample level and a reset level for a double sampling.

In double sampling, a reset value and a signal value are obtained during readout. The reset value may then be subtracted from the signal value during subsequent processing to help correct for noise. The double sampling may be correlated double sampling (in which the reset value is sampled before the signal value) or uncorrelated double sampling (in which the reset value is sampled after the signal value is sampled, sometimes referred to as simply double sampling).

After the E2 sample readout at t₃, the reset transistor may be asserted by pulsing control signal RST at t₄. This may reset the overflow node (e.g., the floating diffusion region 124 and/or capacitor 112). The E2 reset level (RE2) is then sampled (e.g., by asserting the row select transistor). The RE2 sample may be subtracted from the SE2 sample to determine the amount of overflow charge at the overflow nodes. Because the sample level is obtained before the reset level, the E2 sampling is an example of uncorrelated double sampling (not correlated double sampling). The E2 sample may therefore be referred to as an uncorrelated double sample. There is more noise than if correlated double sampling was performed. However, since the overflow charge is generated during relatively high light exposure conditions, the noise may not significantly impact the image data (e.g., the signal-to-noise ratio will remain sufficiently high).

Also at t₄, the TXOF control signal is lowered. This increases the capacity of photodiode 102 (e.g., a larger amount of charge can accumulate in PD 102 without overflowing). Charge continues to accumulate in the photodiode even when the overflow node values are being sampled at t₃ and t₄. The photodiode integration time 210 concludes at t₅ when the reset transistor is asserted to reset the floating diffusion region. The E1 reset level (RE1) is then obtained. The E1 readout may refer to readout of the non-overflow charge (that is stored at photodiode 102 at the end of integration time 210). At t₆, TXOF is asserted to transfer charge from the photodiode to the floating diffusion region. This E1 sample level (SE1) is then read out (by asserting the row select transistor). The RE1 sample may be subtracted from the SE1 sample to determine the amount of charge present in the photodiode at the end of the integration period. Because the sample level is obtained after the reset level, the E1 sampling is an example of correlated double sampling (and may be referred to as a correlated double sample).

In the overflow operation of FIG. 8, there is an overflow integration time 208 during which TXOF is kept at an intermediate level to allow charge to overflow to one or more overflow nodes. The overflow integration time overlaps with the photodiode integration time. After the overflow integration time and during the overflow sampling, the photodiode is not reset, allowing the photodiode integration time to proceed unabated. This allows for a long integration time for the photodiode which is optimal for low light conditions as well as a shorter, high capacity integration time for the overflow charge which is optimal for high light conditions.

The ratio of the lengths of time of integration times 210 and 208 may be any desired ratio (e.g., 2:1, 3:1, more than 1:1, more than 2:1, more than or equal to 2:1, more than 3:1, more than 5:1, more than 10:1, more than 20:1, less than 1:1, less than 2:1, less than 3:1, less than 5:1, less than 10:1, less than 20:1, between 1.5:1 and 3.5:1, between 1:1 and 10:1, between 2:1 and 4:1, between 2:1 and 3:1, etc.). The length of time of integration time 208 may be greater than one microsecond, greater than three microseconds, greater than five microseconds, greater than ten microseconds, greater than fifty microseconds, less than one microsecond, less than three microseconds, less than five microseconds, less than ten microseconds, less than fifty microseconds, between five and twenty microseconds, etc. The length of time of integration time 210 may be greater than one microsecond, greater than three microseconds, greater than five microseconds, greater than ten microseconds, greater than fifty microseconds, greater than one hundred microseconds, less than one microsecond, less than three microseconds, less than five microseconds, less than ten microseconds, less than fifty microseconds, less than one hundred microseconds, between five and twenty microseconds, between five and fifty microseconds, etc. The integration times may be selected to be sufficiently long to detect flickering light-emitting diodes in the captured scene.

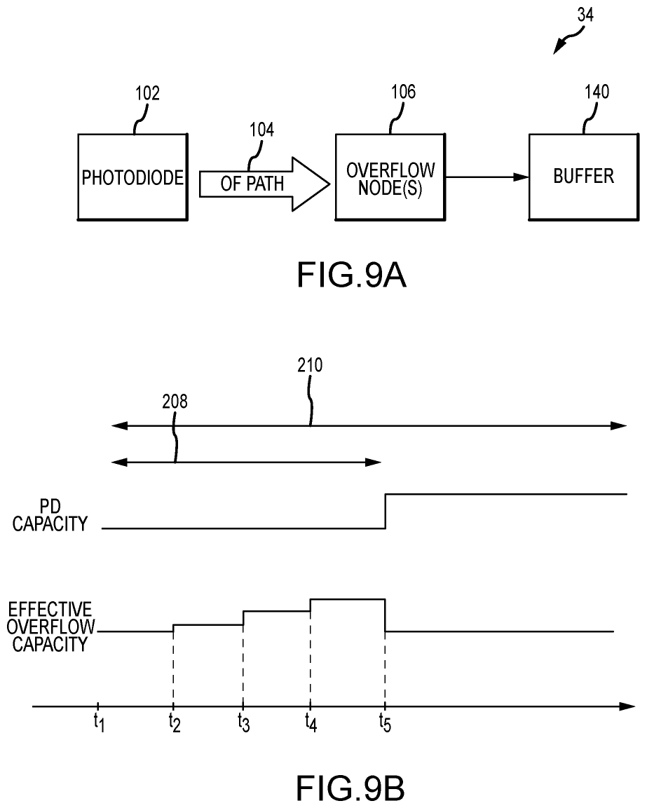

FIG. 9A is a schematic diagram of an imaging pixel that includes a buffer in addition to overflow nodes 106 and photodiode 102. Similar to as discussed in connection with FIG. 3A, charge may overflow from photodiode 102 to overflow node 106 via overflow path 104. In addition, the imaging pixel may include a buffer 140 that repeatedly integrates charge from the overflow nodes. For example, the overflow node is sampled and reset multiple times throughout the overflow integration time 208. This effectively increases the overflow capacity.

FIG. 9B is a timing diagram illustrating how the overflow node may be reset multiple times throughout integration time 208. At t₂, charge from the overflow node is added to buffer 140 then the overflow node is reset. This effectively doubles the capacity of the overflow integration time. In other words, the capacity of the overflow nodes at a given point in time may be x. With each reset, the effective capacity of the overflow nodes increases by x. So at t₂, the effective capacity becomes 2×, at t₃, the effective capacity becomes 3×, and at t₄, the effective capacity becomes 4×. Increasing the effective overflow capacity in this manner increases the dynamic range of the imaging pixel.

At t₅, the photodiode capacity is increased. The photodiode charge may be read out after the conclusion of photodiode integration time 210. Overflow charge may optionally be sampled at the end of integration time 210 in addition to throughout overflow integration time 208.

The times at which the overflow charge is readout and then reset (e.g., t₂, t₃, t₄, and t₅ in FIG. 9B) may be predetermined. In other words, each imaging frame may have the overflow reset at the same relative time (e.g., the first reset is y seconds after the start of the integration time, the second reset is z seconds after the start of the integration time, etc.). The overflow readouts/resets may occur at regular intervals or irregular intervals (e.g., the time difference between each subsequent readout may be the same or may be different). In some cases, different imaging frames may have different relative timing for the overflow readouts/resets. However, the timing of the overflow readouts/resets may be independent of accumulated overflow charge (e.g., control circuitry determines the timing of the overflow readouts/resets for the frame in advance).

Buffer 140 may be incorporated into each imaging pixel in the array of imaging pixels or may incorporated at the periphery of the array of imaging pixels. In some cases, buffer 140 may be shared between multiple pixels. Buffer 140 may be a storage capacitor, storage diode, storage gate, a digital accumulator, or any other desired component. In general, the buffer may sum the samples from the overflow nodes in the digital or analog domain and may be located at any desired location within the image sensor.

In one illustrative example, control circuitry such as column control and readout circuitry 42 and/or control and processing circuitry 44 in FIG. 2 may include the buffer 140. In this example, the buffer is therefore positioned off of the array (e.g., at the periphery of the image sensor chip, in an additional chip that is stacked with the image sensor chip, etc.). This may allow for repeated double sampling of overflow charge throughout the overflow integration time.

This example of the buffer being included in control circuitry such as column control and readout circuitry 42 and/or control and processing circuitry 44 is merely illustrative. Another possible arrangement is for each imaging pixel to have an in-pixel buffer.

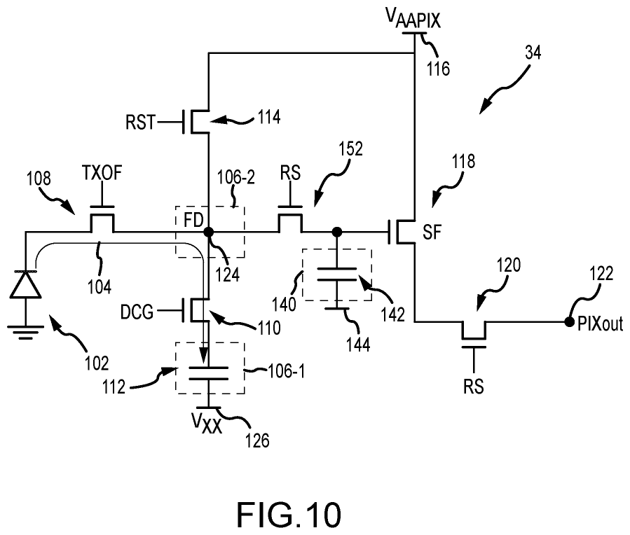

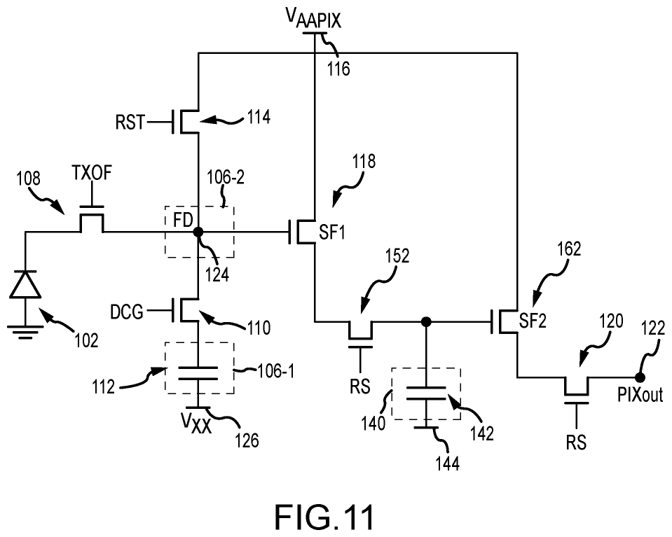

FIGS. 10 and 11 are examples of imaging pixels with a buffer 140. FIG. 10 is a circuit diagram of an imaging pixel with a buffer that is interposed between the floating diffusion region and the source follower transistor. The pixel of FIG. 10 has a similar arrangement to the pixel of FIG. 5. In particular, imaging pixel 34 of FIG. 10 includes a photodiode 102, a floating diffusion region 124, a transistor 108 coupled between the photodiode and the floating diffusion region, a source follower transistor 118, a row select transistor 120 coupled to the source follower transistor, a reset transistor 114, a voltage supply terminal 116 that provides power supply voltage V_{AAPIX}, a gain select transistor 110 coupled between floating diffusion region 124 and capacitor 112, a capacitor 112 coupled between gain select transistor 110, and a bias voltage supply terminal 126 that provides bias voltage V_{XX}. These duplicate components will not be described again to avoid repetition.

In addition, the imaging pixel of FIG. 10 includes a capacitor 142 that serves as buffer 140. Capacitor 142 has a first plate that is coupled to a node that is interposed between transistor 152 and source follower transistor 118. Transistor 152 may receive the same control signal as transistor 120 or may receive a different (unique) control signal). The capacitor may have a second plate that is coupled to bias voltage supply terminal 144.

Similar to as discussed in connection with FIG. 9A, the imaging pixel of FIG. 10 includes a photodiode 102 and overflow nodes 106. Specifically, in the imaging pixel of FIG. 10, capacitor 112 may serve as a first overflow node 106-1 and floating diffusion region 124 may serve as a second overflow node 106-2. Charge follows overflow path 104 from photodiode 102 to overflow node 106-1 and/or 106-2. Transistor 152 may then be intermittently pulsed to transfer charge to buffer 140. Charge from the overflow nodes is therefore summed in capacitor 142.

The example of FIG. 10 is merely illustrative. As shown in FIG. 11, buffer 140 may instead be formed between transistor 152 and an additional source follower transistor 162. Transistor 152 is formed between source follower 118 and storage capacitor 142. Row select transistor 120 is coupled between source follower transistor 162 and output terminal 122.

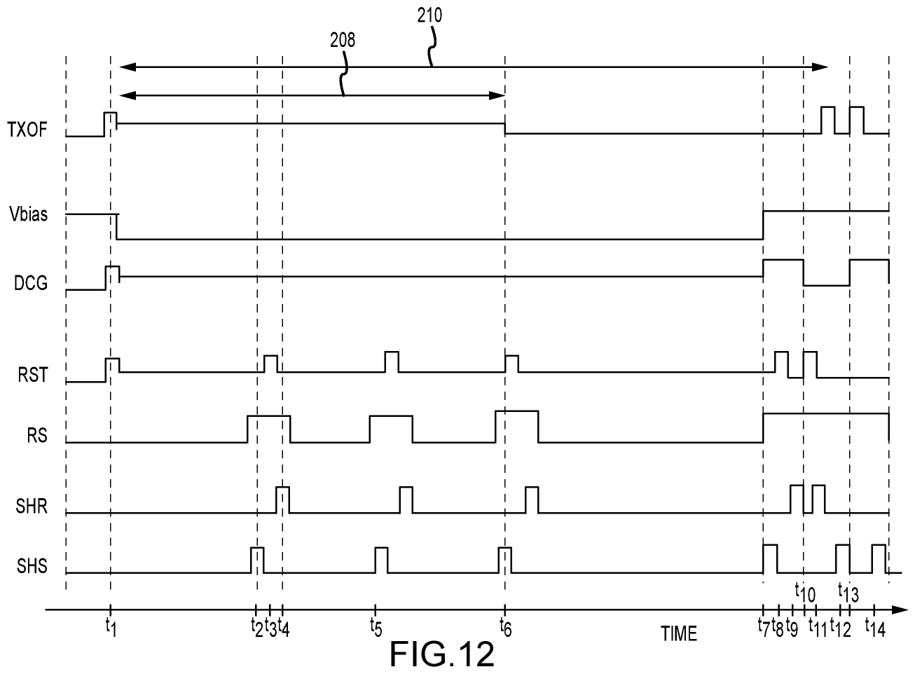

FIG. 12 is a timing diagram showing an illustrative method of operation of an imaging pixel with an overflow path and a buffer (e.g., the imaging pixels of FIGS. 4-7 with an off-array buffer and/or the imaging pixels of FIGS. 10 and 11 with an in-pixel buffer). Although the pixels have variations as previously discussed, the principles shown in the timing diagram of FIG. 12 may applicable to all of the depicted pixels. Minor modifications may be made to the timing diagram to suit the particular design of the imaging pixel being used and the application of the imaging pixel. For simplicity, the timing diagram will be discussed relative to FIG. 5 (where the pixel output is provided to a buffer 140 as discussed in connection with FIGS. 9A and 9B).

Initially, at t₁, reset transistor 114, threshold transistor 108, and gain select transistor 110 may all be asserted. This resets the charge at floating diffusion region 124, photodiode 102, and capacitor 112. The bias voltage V_{BIAS} provided to terminal 126 (sometimes referred to as V_{XX}) may be high during the reset period then dropped low after t₁. Keeping V_{XX} low during the integration time may minimize dark current in the imaging pixel. After the reset period, the TXOF control signal for transistor 108 is set to an intermediate value. This sets a potential barrier for charge accumulating in the photodiode. Once the accumulating charge exceeds the potential barrier, the charge overflows to an overflow node (e.g., floating diffusion region 124 and/or storage capacitor 112). The DCG control signal may be held at an intermediate level to allow overflow charge to be distributed between the floating diffusion region and storage capacitor.

Throughout the integration period, the charge at the overflow node may be sampled then subsequently reset. At t₂, the charge from the overflow nodes may be sampled (e.g., by asserting row select transistor 120). The readout may begin with an E2 sample (SE2) that is obtained at t₃. The E2 readout may refer to readout of the overflow charge (that is stored at floating diffusion region 124 and/or storage capacitor 112). The E2 readout may include readout of a sample level and a reset level for a double sampling.

After the E2 sample is obtained at t₂, the overflow nodes may be reset at t₃. The reset transistor may be asserted to reset the charge at the storage capacitor and floating diffusion region. Then the E2 reset level (RE2) is sampled (e.g., by asserting the row select transistor) at t₄. The RE2 sample may be subtracted from the SE2 sample to determine the amount of overflow charge at the overflow nodes. Because the sample level is obtained before the reset level, the E2 sampling is an uncorrelated double sample. There is therefore more noise than if correlated double sampling was performed. However, since the overflow charge is generated during relatively high light exposure conditions, the noise may not significantly impact the image data (e.g., the signal-to-noise ratio will remain sufficiently high).

This process of obtaining an uncorrelated double sample of the charge at the overflow nodes is repeated during integration period 208. In FIG. 12, the process is repeated at t₅ and then again at the end of the integration period 208 at t₆. After each uncorrelated double sampling, the total value obtained may be added to a buffer 140 (e.g., a buffer within column control and readout circuitry 42 and/or control and processing circuitry 44). Therefore, the overflow charge capacity is increased from x (between t₁ and t₂) to 2× (between t₂ and t₅) and then to 3× (between t₅ and t₆). The example of sampling the overflow nodes twice before the end of the overflow integration time is merely illustrative. In general, the overflow node may be sampled and reset any desired total number of times during the overflow integration time. For example, the overflow node may be sampled and reset just once (as in FIG. 8), twice, three times (as in FIG. 12), four times (as in FIG. 9B), five times, more than five times, more than six times, more than eight times, more than ten times, more than twenty times, etc. An optional additional overflow readout may be performed at the end of photodiode integration time 210, as is shown in FIG. 12.

Throughout overflow integration time 208 and subsequent to overflow integration time 208, charge accumulates in photodiode 102 in a photodiode integration period 210. After the sampling at t₆ TXOF may be lowered, increasing the capacity of the photodiode. At t₇, t₈, and t₉ an optional final uncorrelated double sampling of the overflow nodes may be performed (to detect any additional charge that overflowed the photodiode between t₆ and t₇ despite the increased capacity of the photodiode during this time period). The sample level is obtained, the overflow nodes are reset, and the reset level is obtained similar to the earlier overflow uncorrelated double samplings. This charge may also be added to buffer 140 that includes summed overflow charge from the overflow integration time 208. During the final overflow sampling starting at t₇, gain select transistor 110 is asserted (e.g., DCG is high). This readout is therefore a low conversion gain readout.

At t₁₀, the gain select transistor is deasserted for a high conversion gain readout of the charge in the photodiode. The floating diffusion region is reset at t₁₀ then the E1 reset level is sampled at t₁₁. The transfer transistor is then asserted to transfer charge from the photodiode to the floating diffusion region and the sample level is obtained at t₁₂. This E1 sample level may be subtracted from the E1 reset level to obtain a high conversion gain correlated double sampling E1 result. At t₁₃, the gain select transistor is asserted and the sample level is then sampled again at t₁₄ for a low conversion gain E1 result.

The total overflow signal (e.g., from the buffer) and the signal from the photodiode (e.g., the E1 readout) may be combined (linearized) into a single representative pixel output signal.

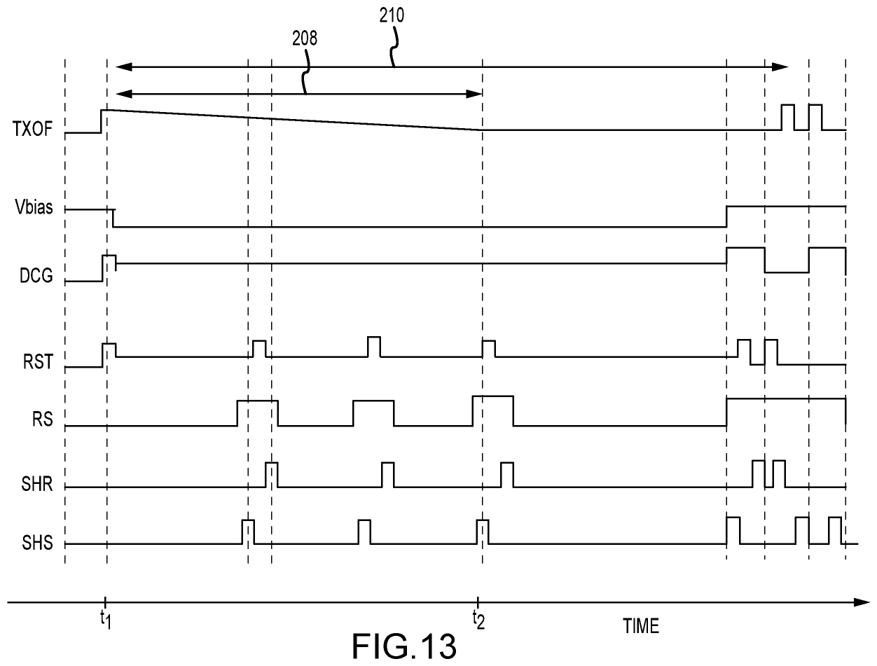

FIG. 13 is a timing diagram illustrating how the overflow control signal TXOF may be varied during the overflow integration time. The rest of the timing diagram is the same as in FIG. 12. However, as shown in FIG. 13, between t₁ and t₂ the control signal TXOF may be ramped downwards. This example is merely illustrative. The TXOF signal may be changed according to a step function in another embodiment. In another possible embodiment, the TXOF signal may be repeatedly pulsed between a single intermediate level and a low level at which the overflow transistor is deasserted. This may reduce dark current at the sacrifice of reducing the overflow capacity.

In the example of FIG. 8, only one overflow readout is performed before the photodiode readout. This example is merely illustrative. In FIG. 8, even if there is no repeated sampling and adding to a buffer throughout integration period 208, there may be a subsequent overflow sampling just before the photodiode sampling (as in FIG. 12) to capture additional overflow charge.

The foregoing is merely illustrative of the principles of this invention and various modifications can be made by those skilled in the art. The foregoing embodiments may be implemented individually or in any combination.

What is claimed is:

1. An image sensor comprising:
a photodiode;
at least one charge storage region;
a transistor that is interposed between the photodiode and the at least one charge storage region, wherein the transistor is configured to set a potential barrier and wherein charge in the photodiode exceeding the potential barrier overflows the transistor into the at least one charge storage region; and
readout circuitry configured to repeatedly sample charge from the at least one charge storage region during an overflow integration time.

2. The image sensor defined in claim 1, further comprising:
a buffer, wherein each sample from the at last one charge storage region is summed in the buffer.

3. The image sensor defined in claim 1, wherein the at least one charge storage region comprises a floating diffusion region and wherein the transistor is interposed between the photodiode and the floating diffusion region.

4. The image sensor defined in claim 3, wherein the at least one charge storage region additionally comprises a storage capacitor and wherein the image sensor further comprises:
a voltage supply terminal;
a reset transistor coupled to the voltage supply terminal; and
a gain select transistor coupled between the floating diffusion region and the storage capacitor, wherein the storage capacitor is coupled between the storage capacitor and the reset transistor.

5. The image sensor defined in claim 4, wherein the image sensor further comprises:
a source follower transistor having a gate coupled to the floating diffusion region; and
a row select transistor coupled to the source follower transistor.

6. The image sensor defined in claim 3, wherein the at least one charge storage region additionally comprises a storage capacitor and wherein the image sensor further comprises:
a first voltage supply terminal;
a reset transistor coupled between the floating diffusion region and the first voltage supply terminal;
a second voltage supply terminal, wherein the storage capacitor is coupled to the second voltage supply terminal; and
a gain select transistor coupled between the storage capacitor and the floating diffusion region.

7. The image sensor defined in claim 1, wherein the at least one charge storage region comprises a storage capacitor and wherein the transistor is interposed between the photodiode and the storage capacitor.

8. The image sensor defined in claim 1, wherein the image sensor comprises row control circuitry and wherein repeatedly sampling charge from the at least one charge storage region comprises, for each sample:
with the readout circuitry, obtaining a sample level from the at least one charge storage region;
with the row control circuitry, resetting the at least one charge storage region; and
with the readout circuitry, obtaining a reset level from the at least one charge storage region.

9. The image sensor defined in claim 1, further comprising:
row control circuitry configured to provide a control signal to a gate of the transistor, wherein the row control circuitry is configured to provide the control signal at an intermediate level throughout the overflow integration time and wherein the row control circuitry is configured to lower the control signal at the end of the overflow integration time.

10. The image sensor defined in claim 9, wherein the readout circuitry is configured to, after the control signal is lowered for a given period of time, obtain a correlated double sample associated with charge accumulated in the photodiode.

11. An image sensor comprising:
a photodiode for an imaging pixel, wherein the imaging pixel has an overflow integration time and a photodiode integration time;
at least one charge storage region;
an overflow transistor that is interposed between the photodiode and the at least one charge storage region, wherein the overflow transistor has a gate;
row control circuitry configured to provide a control signal to the gate at an intermediate level during the overflow integration time and lower the control signal at the end of the overflow integration time; and
readout circuitry configured to sample charge from the at least one charge storage region at the end of the overflow integration time and sample charge from the photodiode at the end of the photodiode integration time.

12. The image sensor defined in claim 11, wherein a ratio of a duration of the photodiode integration time to a duration of the overflow integration time is greater than or equal to 2:1.

13. The image sensor defined in claim 11, wherein the overflow integration time is a subset of the photodiode integration time.

14. The image sensor defined in claim 11, wherein the overflow integration time and the photodiode integration time start simultaneously at a first time, wherein the overflow integration time ends at a second time, and wherein the photodiode integration time ends at a third time that is subsequent to the second time.

15. The image sensor defined in claim 11, wherein the row control circuitry is configured to provide the control signal at a single, uniform intermediate level during the overflow integration time.

16. The image sensor defined in claim 11, wherein the row control circuitry is configured to dynamically change the intermediate level during the overflow integration time.

17. The image sensor defined in claim 11, wherein the readout circuit is configured to sample charge from the at least one charge storage region at multiple times during the overflow integration time.

18. The image sensor defined in claim 17, wherein the samples from the at least one charge storage region during the overflow integration time are uncorrelated double samples.

19. The image sensor defined in claim 18, wherein the sample from the photodiode at the end of the photodiode integration time is a correlated double sample.

20. A method of operating an image sensor that includes a photodiode, an overflow node, a buffer, and an overflow path between the photodiode and the overflow node, the method comprising:
accumulating charge in the photodiode, wherein some charge overflows from the photodiode to the overflow node via the overflow path;
during an overflow integration time, repeatedly sampling a charge level at the overflow node and adding the charge level to the buffer; and
at the conclusion of a photodiode integration time that is overlapping with the overflow integration time, sampling a charge level from the photodiode.
